(19) United States
(12) Patent Application Publication
(10) Pub. No.: US 2013/0045391 A1
(43) Pub. Date: Feb. 21, 2013

(54) Tarnish Inhibiting Composition for Metal Leadframes

(71) Applicant: Kesheng Feng, Cheshire, CT (US)

(72) Inventor: Kesheng Feng, Cheshire, CT (US)

(21) Appl. No.: 13/213,154

(22) Filed: Aug. 19, 2011

(51) Int. Cl. C09D 5/08; B32B 15/04

(52) U.S. Cl. 428/457; 106/14.14

(57) ABSTRACT

An aqueous tarnish inhibiting solution comprising a mercapto carboxylic acid and a corrosion inhibitor to produce an anti-tarnish layer on metal surfaces, such as silver plated copper leadframes and a method of using the same is provided. The composition provides an improved anti-tarnish layer that does not affect wirebondability or the adhesion of a mold compound to a leadframe.

### FIELD OF THE INVENTION

The present invention relates generally to an improved tarnish inhibiting composition for metal surfaces, such as silver and copper.

### BACKGROUND OF THE INVENTION

Microelectronic circuits such as silicon semiconductor integrated circuits and hybrid microelectronic circuits require a package which both encases the circuit and provides electrical interconnection to external circuitry. A leadframe is one common means of electrical interconnection. The leadframe is formed from a strip of electrically conductive metal which is formed into a plurality of leads. The inner lead ends of the leadframe approach the integrated circuit device from one or more sides and are electrically interconnected to the device by thin bond wires. The outer lead ends of the leadframe are electrically interconnected to external circuitry such as a printed circuit board. Surface mounted devices (SMD's) are plastic encapsulated surface mount packages and other packages with moisture permeable materials.

An integrated circuit is a circuit of transistors, resistors, and capacitors constructed on a single semiconductor wafer or chip, in which the components are interconnected to perform a given function. A typical integrated circuit is comprised of many interconnected transistors and associated passive circuit elements that perform a function or functions. These functions may include, for example, random access memory, central processing and communications. Combining integrated circuits requires electrically connecting each integrated circuit and, in order to accomplish this interconnection, conductive paths must be made available to connect the internal circuitry of an integrated circuit (“IC”) to external electrical circuits.

Typically, a leadframe is used as an interface between the IC and external circuitry for facilitating interconnection. In the case of a lead-on-chip package, the leadframe is designed to align with and connect to integrated circuit connection pads located on a face of the IC chip. These connection pads are the points at which all input and output signals and power and ground connections are made for the IC to function as intended.

The leadframe may be connected to the IC connection pads by wire bonding, tape automated bonding (“TAB”), wedge bonding or other methods well known in the art. Ball or wedge wire bonding may be aligned with the alignment fixture pins and may have a tolerance of 5 mils. TAB bonding requires more precision in the alignment of the lead frames and is normally set into place by means of automatic recognition alignment equipment which achieves a 0.5 to 1 mil tolerance.

Gold wire bonded to silver plated leadframes has been successfully used in the high-volume production of plastic-encapsulated devices. Strong bonding between the gold wire and the silver plated leadframe is crucial for maintaining bondability and reliability during the IC manufacturing process and in IC applications in the field.

Non-stick on lead (“NSOL”) failures during the wedge bonding process of IC packages has been a known problem. The primary causes of NSOL failures are plating bath contamination, such as the presence of copper impurities in the bath, and issues that arise during the annealing process. For example, during die attach curing or the wire bonding process, copper may diffuse onto a silver surface then oxidize and render the gold wire unbondable. Even if the surface metal and the substrate are cleaned during the process, the substrate can diffuse onto the metal surface during storage. This is particularly problematic with silver surfaces, which can also easily be tarnished by sulfur compounds. The combination of copper diffusion and silver surface tarnish during storage of silver coatings can thus cause wire bond failure.

Leadframe tarnishing is a known problem and has lead to various proposed remedies. U.S. Pat. No. 5,817,544 to Parthasarathi, the subject matter of which is herein incorporated by reference in its entirety, describes several mechanisms to improve the bond between a leadframe and a molding resin and to reduce leadframe tarnishing. Several patents describe treating a metal surface by contacting the surface with a solution and/or forming a layer on the surface. For example, U.S. Pat. No. 4,888,449 to Crane et al. describes the application of dull nickel to a leadframe in order to increase an epoxy bond, U.S. Pat. No. 4,428,987 to Bell et al. describes pre-treating a copper surface with a benzotriazole solution to improve adhesion, U.S. Pat. No. 5,122,858 to Mahulikar et al. discloses that coating a leadframe with a thin polymeric layer improves the adhesion between the leadframe and molding resin, and U.S. Pat. No. 5,449,951 to Parthasarathi et al. discloses coating a metallic leadframe with a plurality of layers including a layer comprising either or both of chromium and zinc.

It is important that any antitarnish/anticorrosion layer does not negatively impact wirebondability or the adhesion of mold compounds to a leadframe, and, thus, there remains a need in the art for additional compositions and processes for preventing corrosion and/or tarnishing on metal surfaces. In addition, there also remains a need in the art for an anti-tarnish agent that functions to prevent both copper diffusion and silver tarnish.

### SUMMARY OF THE INVENTION

It is an object of the present invention to inhibit tarnishing on various metal layers.

It is another object of the present invention to reduce diffusion of one metal onto another metal layer.

It is still another object of the present invention to provide an anti-tarnish agent that is capable of at least substantially minimizing both copper diffusion and silver tarnish.

It is still another object of the present invention to provide an anti-tarnish layer on a plated leadframe that will allow for wirebondability.

It is yet another object of the present invention to achieve reduced tarnish of a silver plated leadframe and diffusion of copper while allowing for wirebondability or the adhesion of mold compound to the leadframe.

To that end, in a preferred embodiment, the present invention relates generally to a tarnish inhibiting composition comprising a mercapto carboxylic acid and a corrosion inhibitor.

In another preferred embodiment, the present invention relates generally to a process for reducing tarnish on a metal surface, said metal surface comprising at least one of silver and copper, the process comprising the step of:

contacting the metal surface with a composition comprising a mercapto carboxylic acid and a corrosion inhibitor to produce an anti-tarnish layer thereon.

### DETAILED DESCRIPTION OF THE PREFERRED EMBODIMENTS

The present invention relates generally to an aqueous composition for inhibiting corrosion on metal surfaces and a method of using the same. The use of the aqueous composition described herein causes the formation of an anti-tarnish layer on a metal surface and thereby inhibits tarnishing and corrosion of the surface. In a preferred embodiment, the metal surface that is contactable with the aqueous composition comprises at least one of silver and copper. For example, the metal surface may be a silver coated copper alloy leadframe. Leadframes are typically comprised of copper alloys with one or more of nickel, silicon, magnesium, phosphorous, zinc, iron chromium and/or tin, which are particularly suitable for treatment with this invention.

The inventor of the present invention has found that a tarnish inhibiting aqueous composition comprising both a mercapto carboxylic acid and a corrosion inhibitor has the capability of reducing silver tarnish and minimizing copper diffusion, while at the same time allowing for wirebondability or the adhesion of a mold compound to a leadframe.

The mercapto carboxylic acid is preferably a long-chain mercapto alkyl carboxylic acid, and is more preferably selected from the group consisting of mercaptoundecanoic acid, mercaptohexadecanoic acid, mercaptododecanoic acid, mercapto hexanoic acid, mercaptopentadecanic acid and (mercaptomethyl)cyclopropaneacetic acid. Other long chain mercapto carboxylic acids would also be usable in the practice of the invention and would be known to those skilled in the art.

The mercapto carboxylic acid is preferably present in the composition at a concentration of between about 0.01 g/L and about 10 g/L, more preferably between about 0.5 g/L and about 2 g/L.

The corrosion inhibitor is typically selected from the group consisting of azoles, imidazoles, triazoles, indoles, thiazoles and tetrazoles. However other corrosion inhibitors would also be usable in the compositions of the present invention. In one preferred embodiment, the corrosion inhibitor comprises a benzotriazole. Other preferred corrosion inhibitors include 5-carboxybenzotriazole, and 3-amino-5-mercapto-1,2,4-thiazole.

Preferably, the corrosion inhibitor is present in the composition at a concentration of between about 0.1 g/L and about 5 g/L, more preferably between about 0.5 g/L and about 2 g/L.

In one embodiment, the aqueous tarnish inhibiting composition may comprise a buffer, for example, an alkali carbonate metal salt. The alkali carbonate metal salt is typically sodium carbonate or potassium carbonate. Other buffers are also known to those skilled in the art and would be usable in the compositions described herein. If used, the buffer may be present in the composition at a concentration of between about 2.0 g/L and about 2.0 g/L. Preferably the pH of the composition is maintained between 5 and 14, more preferably between 8 and 11.

The present invention is also directed to a process for reducing tarnish on a metal surface, said metal surface comprising at least one of silver and copper, the process comprising the step of contacting the metal surface with the aqueous tarnish inhibiting composition of the invention to produce an anti-tarnish layer thereon.

By performing this process, a leadframe panel can be coated with the tarnish inhibiting composition of the invention. This process is particularly useful when the metal surface that is being treated comprises silver and thus the anti-tarnish layer minimizes silver tarnish. In a preferred embodiment, leadframe panels are processed in accordance with the following sequence:

1) micro-etching,

2) rinsing with deionized water,

3) post cleaning,

4) treating with the tarnish inhibiting composition,

5) rinsing with deionized water, and

6) drying.

Similarly, contacting a metal surface with a composition comprising a mercapto carboxylic acid and a corrosion inhibitor to produce an anti-tarnish layer thereon prevents deterioration of wirebondability during an annealing process.

In addition, contacting a metal surface with the composition of the invention to produce an anti-tarnish layer thereon allows for the peel strength between the metal surface and an applied mold compound following the application of the anti-tarnish layer to not be substantially reduced from the peel strength of the metal surface prior to the application of the anti-tarnish layer. In a preferred embodiment, the peel strength of the metal surface following the application of the anti-tarnish layer is substantially equal to the peel strength of the metal surface prior to the application of the anti-tarnish layer, and more preferably, the peel strength of the metal surface following the application of the anti-tarnish layer is greater than the peel strength of the metal surface prior to the application of the anti-tarnish layer.

The present invention is further directed to a leadframe panel coated with the tarnish inhibiting composition described above.

### EXAMPLES

In each of the following examples, a silver-coated copper alloy leadframe panel was processed through the following sequence of steps:

1) micro-etching,

2) rinsing with deionized water,

3) post cleaning,

4) treating with the tarnish inhibiting composition,

5) rinsing with deionized water, and

6) drying.

### Humidity/Hydrosulfide Tarnish Chamber:

The treated leadframe panels were tested for tarnish after being placed into a humidity/hydrosulfide tarnish chamber having the following conditions:
1) Preheat the chamber to a temperature of between 40° C. and 45° C., and maintain this temperature range throughout the test.
2) Hang the leadframe panels in the chamber along with a control panel.
3) Prepare a solution of 0.45 g of sodium hydrosulfide in 400 mL of deionized water,
4) Using the prepared solution in the sulfur chamber, place 200 mL of solution in two porcelain disks and add 2 mL of hydrochloric acid to each disks,
5) Close the chamber air tight and monitor the control panel for tarnish.
6) Once the control panel tarnishes, open the chamber and remove all panels.
7) Evaluate the tarnish effect respective to the control panel.

### Oven Baking Condition:

The oven was preheated to 180° C. and panels were hung in the oven for 30 minutes. Then the tarnish on the copper and silver surfaces and the wirebondability were evaluated.

### Peel Strength:

In order to test the adhesion between a metal surface and the mold compound, peel strength can be measured and evaluated. In this instance, a thin layer of mold compound is laminated between a backing plate and a sheet of silver plated copper foil. Complete lamination and curing of the mold compound are accomplished in a vacuum lamination press using controlled heating and pressure.

Thereafter, tape is applied to the silver surface to cover 1-inch wide strips of silver plated copper foil and the composite is etched to dissolve and remove the exposed silver/copper areas. The resulting composite consists of a 1-inch wide strip of silver plated copper laminated to the cured mold compound. A peel test apparatus can then be used to measure the force reading as the peel strength between the silver surface and the mold compound.

### Comparative Example 1

An anti-tarnish solution was made up containing 1.0 g/L of mercaptoundecanoic acid and 4.5 g/L of potassium carbonate in deionized water.

### Comparative Example 2

An anti-tarnish solution was made up containing 1.5 g/L of benzotriazole and 4.5 g/L of potassium carbonate in deionized water.

### Example 1

An antitarnish solution was made up containing 1.5 g/L of benzotriazole, 1.0 g/L of mercaptoundecanoic acid and 4.5 g/L of potassium carbonate in deionized water.

### Results:

After spending 30 minutes in the humidity/hydrosulfide tarnish chamber, the copper alloy of the control leadframe panel (not treated) was tarnished significantly more than the copper alloy of the leadframe panels that were treated in Comparative Examples 1 and 2, both of which were significantly more tarnished than the copper alloy of the leadframe panel that was treated in Example 1. When magnified, it is similarly evident that the silver surface of the leadframe panel that was treated in Example 1 was significantly less tarnished than the silver surfaces of the control panel or the panels treated in Comparative Examples 1 and 2. The silver surfaces from the control panel and from the panel treated in Comparative Example 2 both had sever tarnish and the panel treated in Comparative Example 1 had slight tarnish, while the silver surface that was treated with a solution containing both benzotriazole and mercaptoundecanoic acid had almost no tarnish.

Thus it can be seen that the solution containing both benzotriazole and mercaptoundecanoic acid shows great anti-tarnishing effects for both copper alloy and silver under the humidity/hydrosulfide harsh environment.

Furthermore, after spending 30 minutes in the 180° C. oven, the copper alloy surfaces of the panels treated in Comparative Example 2 and in Example 1 had reduced tarnishing. When magnified, it is also evident that the silver surfaces of the leadframe panels that were treated in Comparative Example 1, Comparative Example 2 and Example 1 were all significantly less tarnished than the silver surface of the control panel. However, the performance of Example 1 far exceeded the performance of the other samples in lack of tarnish.

Additionally, in order to determine whether the antitarnish solution would cause deteriorated adhesion between a silver surface and mold compounds, the peel strength of a silver surface to various mold compounds was tested using the solution prepared in Example 1. The three mold compounds that were tested were Henkel Hysol GR 725 LV™ (available from Henkel Corporation), and Sumitomo EME G600™ and Sumitomo EME G770H™ (available from Sumitomo Plastics America, Inc.).

TABLE 1
Peel Strength comparison

| | Henkel Hysol | Sumitomo | Sumitomo |
|---|---|---|---|
| Mold Compound | GR 725 LV | EME G600 | EME G770H |
| Peel Strength (lb/in) of | 2.0 | 0.8 | 1.2 |
| silver surface not treated | | | |
| with solution prepared in | | | |
| Example 1 | | | |
| Peel Strength (lb/in) of | 2.7 | 0.9 | 1.2 |
| silver surface treated with | | | |
| solution prepared in | | | |
| Example 1 | | | |

As shown in Table 1, the peel strength of Sumitomo EME G600™ and Sumitomo EME G770H™ is substantially equal regardless of whether the silver surface is treated with the solution containing benzotriazole and mercaptoundecanoic acid. Moreover, the peel strength of Henkel Hysol GR 725 LV™ is greater when the silver surface is treated with the solution containing both benzotriazole and mercaptoundecanoic acid than when the surface is not treated.

Wirebondability of a silver plated copper alloy leadframe panel that was treated with the solution prepared in Example 1 was tested and compared to the wirebondability of a leadframe panel that was not treated with the solution. All bonds were made after simulated die attach cure for 45 minutes at 180° C. All pull locations were 25-30% of the distance between stitch and ball bonds, as depicted in FIG. 5. Tests were performed with the silver being pulled at the center of a silver strip and, separately, with the silver being pulled at the edge of a silver strip, and separate tests were performed when the panels had not aged, after they had been placed in the oven for 30 minutes at 180° C., and after they had been placed in the humidity/hydrosulfide tarnish chamber for 30 minutes. As can be seen from the data in Tables 2 and 3, treating the panel with the solution prepared in Example 1 prevents the deterioration of wirebondability from harsh environments.

TABLE 2
Pull Location At Center of Ag Stripe

| | | | After 30 minutes in |
|---|---|---|---|
| | | After 30 | humidity/ |
| | | minutes in | hydrosulfide tarnish |
| Sample | No aging | 180° C. oven | chamber |
| Leadframe panel | 12.31 | 8.05 | 6.83 |
| processed through | | | |
| microetching and | | | |
| post clean | | | |
| Leadframe panel | 12.23 | 10.08 | 8.24 |
| processed through | | | |
| micro etching, post | | | |
| clean and treatment | | | |
| with antitarnish | | | |
| solution prepared in | | | |
| Example 1 | | | |

TABLE 3
Pull Location At Edge of Ag Stripe

| | | | After 30 minutes in |
|---|---|---|---|
| | | After 30 | humidity/ |
| | | minutes in | hydrosulfide tarnish |
| Sample | No aging | 180° C. oven | chamber |
| Leadframe panel | 9.44 | 6.67 | 5.80 |
| processed through | | | |
| microetching and | | | |
| post clean | | | |
| Leadframe panel | 11.48 | 11.94 | 8.88 |
| processed through | | | |
| micro etching, post | | | |
| clean and treatment | | | |
| with antitarnish | | | |
| solution prepared in | | | |
| Example 1 | | | |

It can thus be see that the provided tarnish inhibiting composition and process for applying an anti-tarnish layer overcome the perceived deficiencies in the prior art. In particular, the improved composition and process as set forth herein effectively achieve reduced tarnish and diffusion while not negatively impacting wirebondability or the adhesion of a mold compound to a leadframe.

What is claimed is:

1. An aqueous tarnish inhibiting composition comprising a mercapto carboxylic acid and a corrosion inhibitor.

2. The aqueous tarnish inhibiting composition according to claim 1, wherein the mercapto carboxylic acid is a long-chain mercapto alkyl carboxylic acid.

3. The aqueous tarnish inhibiting composition according to claim 1, wherein the mercapto carboxylic acid is selected from the group consisting of mercaptoundecanoic acid, mercaptohexadecanoic acid, mercaptododecanoic acid, mercapto hexanoic acid, mercaptopentadecanic acid and (mercaptomethyl)cyclopropaneacetic acid.

4. The aqueous tarnish inhibiting composition according to claim 3, wherein the corrosion inhibitor is selected from the group consisting of azoles, imidazoles, triazoles, indoles, thiazoles and tetrazoles.

5. The aqueous tarnish inhibiting composition according to claim 3, wherein the corrosion inhibitor comprises a benzotriazole.

6. The aqueous tarnish inhibiting composition according to claim 1, further comprising a buffer.

7. The aqueous tarnish inhibiting composition according to claim 6, wherein the buffer is an alkali carbonate metal salt.

8. The tarnish inhibiting composition according to claim 7, wherein the alkali carbonate metal salt comprises sodium carbonate or potassium carbonate.

9. The tarnish inhibiting composition according to claim 1, wherein the mercapto carboxylic acid is present in the composition at a concentration of between about 0.01 g/L and about 10 g/L.

10. The tarnish inhibiting composition according to claim 9, wherein the mercapto carboxylic acid is present in the composition at a concentration of between about 0.5 g/L and about 2 g/L.

11. The tarnish inhibiting composition according to claim 1, wherein the corrosion inhibitor is present in the composition at a concentration of between about 0.1 g/L and about 5 g/L.

12. The tarnish inhibiting composition according to claim 11, wherein the corrosion inhibitor is present in the composition at a concentration of between about 0.5 g/L and about 2 g/L.

13. The tarnish inhibiting composition according to claim 6, wherein the buffer is present in the composition at a concentration of between about 2.0 g/L and about 20 g/L.

14. A process for reducing tarnish on a metal surface, said metal surface comprising at least one of silver and copper, the process comprising the step of:
contacting the metal surface with a composition comprising a mercapto carboxylic acid and a corrosion inhibitor to produce an anti-tarnish layer thereon.

15. The process according to claim 14, wherein the metal surface comprises silver and the anti-tarnish layer prevents silver tarnish.

16. The process according to claim 14, wherein the mercapto carboxylic acid is a long chain mercapto alkyl carboxylic acid.

17. The process according to claim 16, wherein the mercapto carboxylic acid is selected from the group consisting of mercaptoundecanoic acid, mercaptohexadecanoic acid, mercaptododecanoic acid, mercapto hexanoic acid, mercaptopentadecanic acid and mercaptomethyl)cyclopropaneacetic acid.

18. The process according to claim 14, wherein the corrosion inhibitor is selected from the group consisting of azoles, imidazoles, triazoles, indoles, thiazoles and tetrazoles.

19. The process according to claim 14, wherein the corrosion inhibitor comprises a benzotriazole.

20. The process according to claim 14, further comprising a buffer.

21. The process according to claim 20, wherein the buffer is an alkali carbonate metal salt.

22. The process according to claim 21, wherein the alkali carbonate metal salt comprises sodium carbonate or potassium carbonate.

23. The process according to claim 14, wherein the mercapto carboxylic acid is present in the composition at a concentration of between about 0.01 g/L and about 10 g/L.

24. The process according to claim 23, wherein the mercapto carboxylic acid is present in the composition at a concentration of between about 0.5 g/L and about 2 g/L.

25. The process according to claim 14, wherein the corrosion inhibitor is present in the composition at a concentration of between about 0.1 g/L and about 5 g/L.

26. The process according to claim 25, wherein the corrosion inhibitor is present in the composition at a concentration of between about 0.5 g/L and about 2 g/L.

27. The process according to claim 20, wherein the buffer is present in the composition at a concentration of between about 2.0 g/L and about 20 g/L.

28. The process according to claim 14, wherein the peel strength of the metal surface following the application of the anti-tarnish layer is substantially equal to the peel strength of the metal surface prior to the application of the anti-tarnish layer.

29. The process according to claim 14, wherein the peel strength of the metal surface following the application of the anti-tarnish layer is greater than the peel strength of the metal surface prior to the application of the anti-tarnish layer.

30. The process according to claim 14, wherein the application of the anti-tarnish layer to the metal surface prevents deterioration of wirebondability during an annealing process.

31. A leadframe panel coated by the process of claim 14.

32. The leadframe panel according to claim 31, wherein the peel strength of the metal surface following the application of the anti-tarnish layer is substantially equal to the peel strength of the metal surface without application of the anti-tarnish layer.
